(19) United States
(12) Patent Application Publication
(10) Pub. No.: US 2023/0294588 A1
(43) Pub. Date: Sep. 21, 2023

(54) BOAT CARRIER

(71) Applicant: YOTTA INNOVATION CO., LTD., Apia (WS)

(72) Inventor: STELLA HUANG, Taipei City (TW)

(21) Appl. No.: 17/695,379

(22) Filed: Mar. 15, 2022

(51) Int. Cl. B60P 3/10

(52) U.S. Cl. CPC B60P 3/1075

(57) ABSTRACT

A boat carrier is provided, including a frame, an upper supporting assembly and a lower supporting assembly. The frame has a base and a first rod assembly. The first rod assembly is disposed on the base. The first rod assembly extends in a Z direction. The upper supporting assembly is connected to the first rod assembly. The lower supporting assembly is connected to the first rod assembly. The lower supporting assembly includes at least one lower supporting member. The at least one lower supporting member includes a first supporting segment and a second supporting segment which extend in a Y direction. A first included angle directed toward an X direction is defined between the first supporting segment and the second supporting segment.

### BACKGROUND OF THE INVENTION

### Field of the Invention

The present invention relates to a boat carrier.

### Description of the Prior Art

With boats such as kayaks, dinghies or canoes, people can do various exercises on rivers, lakes, rapids or the ocean, and enjoy the scenery from another perspective and get closer to nature. In addition, during rowing, arm muscles, shoulder muscles, back muscles, chest muscles and/or abdominal muscles are trained and enhanced.

In daily life, the boat is generally secured to the roof rack on the roof of the car, and transported to the place where the water activities are performed. However, in this conventional way, the boat can protrude beyond the car frontward and rearward, which not only obstructs the driver's vision in front of the car but also causes the driver to fail to evaluate the level of protrusion of the boat beyond the car rearward when moving rearward, which is prone to collision. Additionally, during the car is moving, the boat is prone to fall from the car.

The present invention is, therefore, arisen to obviate or at least mitigate the above-mentioned disadvantages.

### SUMMARY OF THE INVENTION

The main object of the present invention is to provide a boat carrier which can restrict and hold a boat body effectively and firmly.

To achieve the above and other objects, a boat carrier is provided, including: a frame, including a base and a first rod assembly, the base being configured to be connected to a vehicle, the first rod assembly being connected to the base, the first rod assembly extending in a Z direction; an upper supporting assembly, connected to the first rod assembly, including at least one upper supporting member; and a lower supporting assembly, connected to the first rod assembly, distanced from and located under the upper supporting assembly in the Z direction, including at least one lower supporting member, the at least one lower supporting member including a first supporting segment and a second supporting segment which extend in a Y direction, the first supporting segment and the second supporting segment defining a first included angle therebetween, the first included angle being directed toward an X direction, wherein the X, Y Z directions are perpendicular to one another.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a partial cross-sectional view in a Z direction according to a preferable embodiment of the present invention;

FIG. 3 is a drawing showing operation of a preferable embodiment of the present invention;

FIGS. 4 and 5 are drawings showing operation of unfolding/folding according to a preferable embodiment of the present invention;

FIG. 6 is a partial breakdown drawing of FIG. 4;

FIG. 7 is a drawing showing a part of a lower supporting assembly as viewed the Z direction in according to FIG. 6 a preferable embodiment of the present invention; and

FIG. 8 is a drawing showing a part of a lower supporting assembly as viewed an X direction in according to FIG. 6 a preferable embodiment of the present invention.

### DETAILED DESCRIPTION OF THE PREFERRED EMBODIMENTS

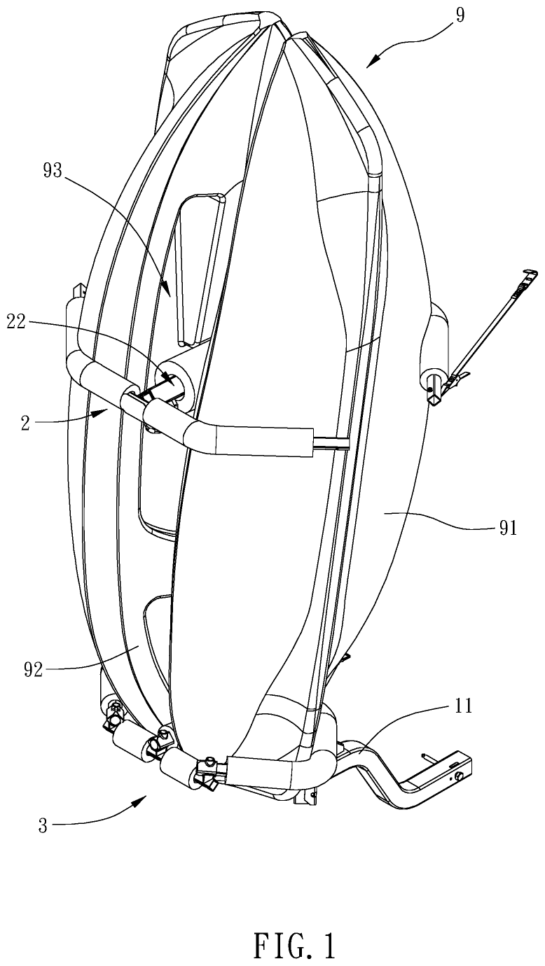

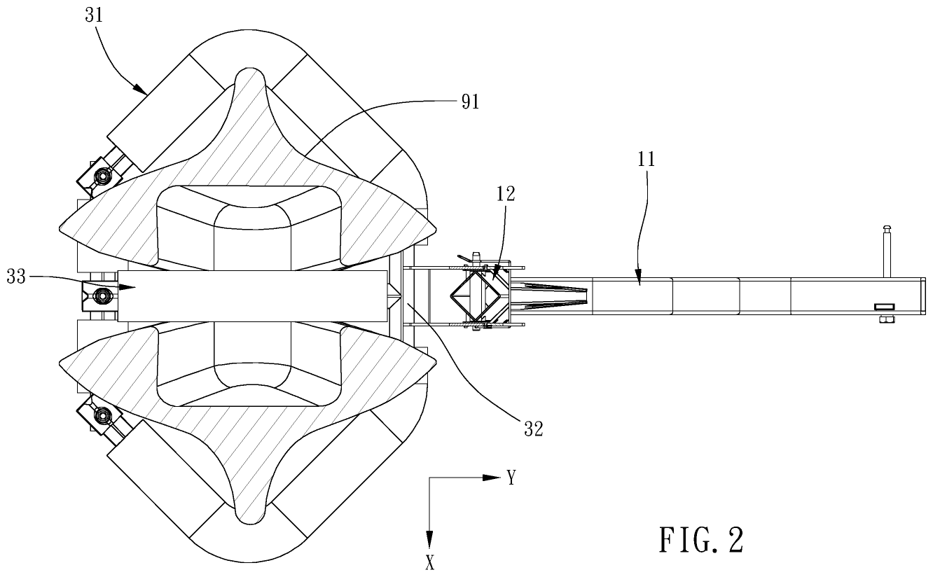

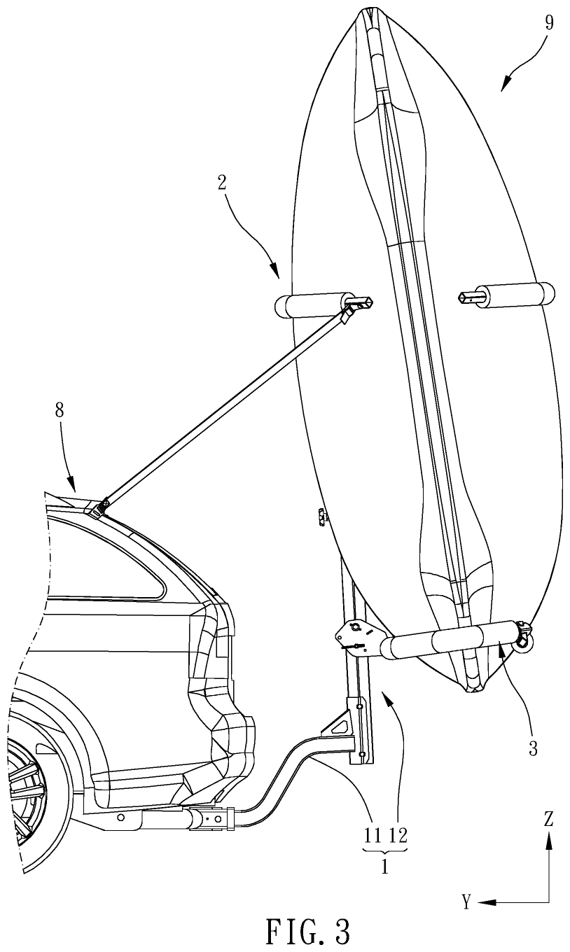

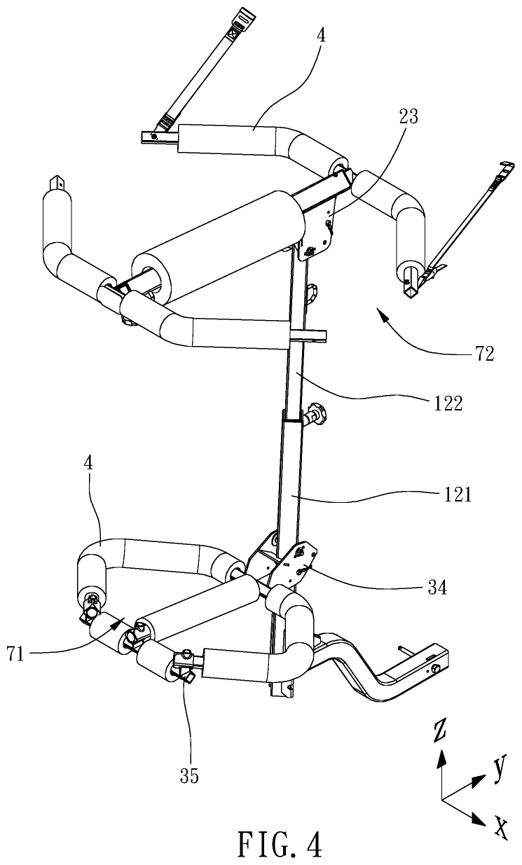

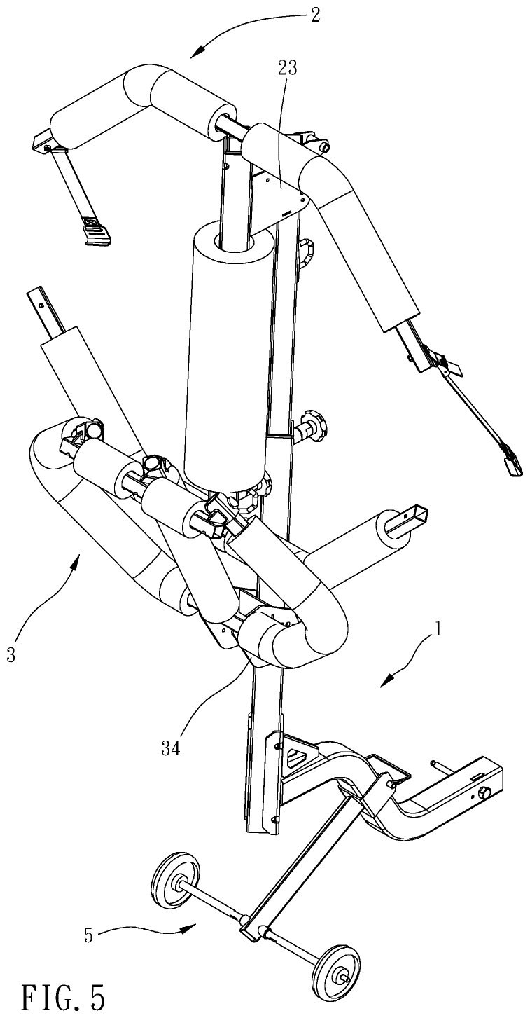

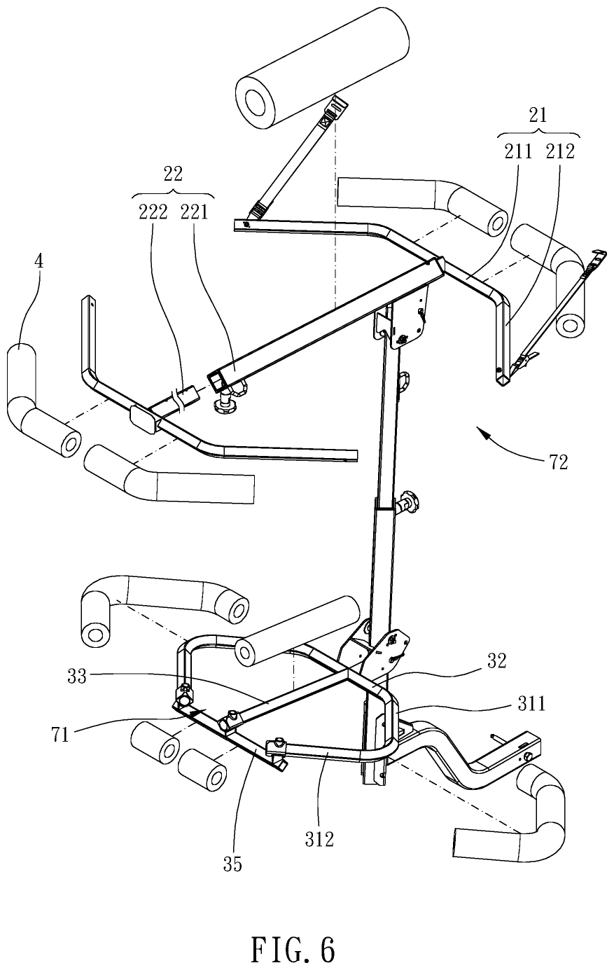

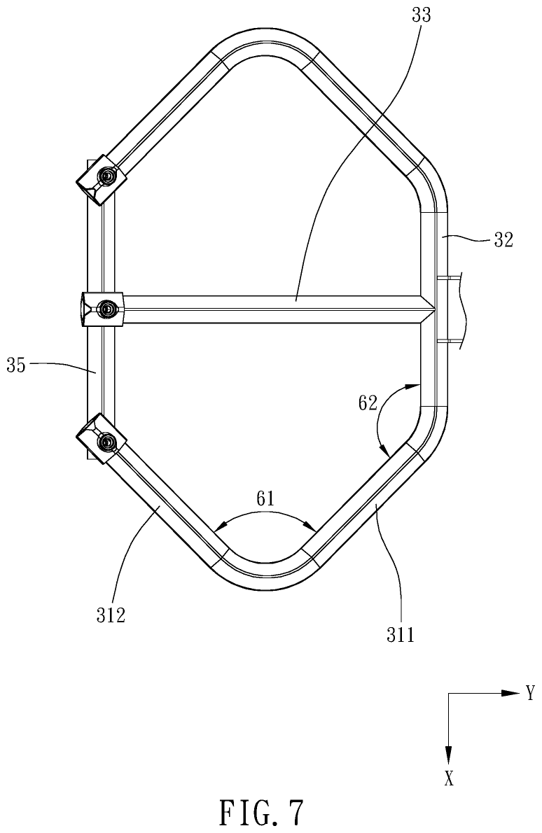

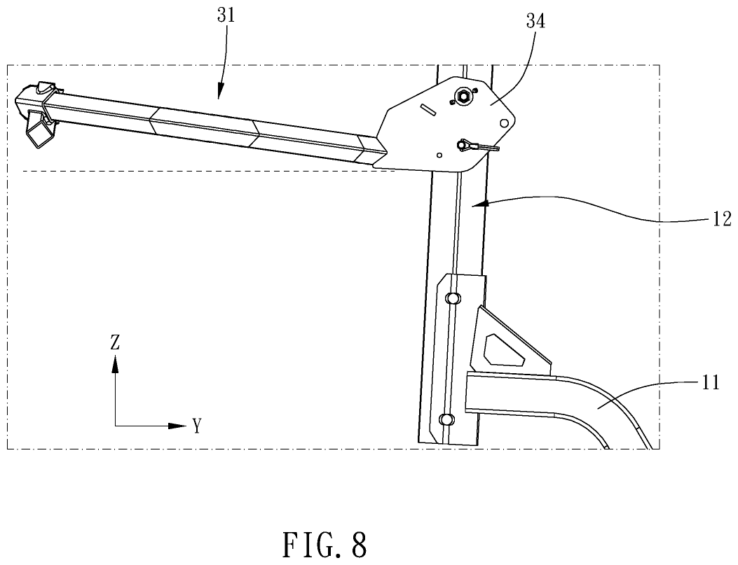

Please refer to FIGS. 1 to 8 for a preferable embodiment of the present invention. A boat carrier of the present invention includes a frame 1, an upper supporting assembly 2 and a lower supporting assembly 3.

The frame 1 includes a base 11 and a first rod assembly 12, the base 11 is configured to be connected to a vehicle 8, the first rod assembly 12 is connected to the base 11, and the first rod assembly 12 extends in a Z direction. The upper supporting assembly 2 is connected to the first rod assembly 12, and the upper supporting assembly 2 includes at least one upper supporting member 21. The lower supporting assembly 3 is connected to the first rod assembly 12, the lower supporting assembly 3 is distanced from and located under the upper supporting assembly 2 in the Z direction, the lower supporting assembly 3 includes at least one lower supporting member 31, the at least one lower supporting member 31 includes a first supporting segment 311 and a second supporting segment 312 which extend in a Y direction, the first supporting segment 311 and the second supporting segment 312 define a first included angle 61 therebetween, and the first included angle 61 is directed toward an X direction, wherein the X, Y Z directions are perpendicular to one another. A boat body 9 is configured to be disposed through the upper supporting assembly 2 and the lower supporting assembly 3 in the Z direction, the first supporting segment 311 and the second supporting segment 312 are configured to restrict a bottom portion 91 of the boat body 9 so that the boat body 9 is restricted in the X direction and the Y direction.

Preferably, the at least one lower supporting member 31 is configured to restrict an end portion of the boat body 9, thus matching the shape of the boat body 9. Whereby, the boat body 9 can be well held by downward movement thereof in the Z direction (even during transportation on a bumping road), and the at least one lower supporting member 31 can hold the boat body 9 effectively and firmly.

Preferably, the first rod assembly 12 includes a base rod 121 and an extension rod 122, the base rod 121 is disposed on the base 11, the extension rod 122 is movably inserted to the base rod 121, the upper supporting assembly 2 is connected to the extension rod 122, and the lower supporting assembly 3 is connected to the base rod 121, so that the distance between the upper supporting assembly 2 and the lower supporting assembly 3 can be adjusted according to the extent of the boat body 9 in the Z direction to effectively restrict the boat body 9.

Preferably, the boat carrier further includes at least one buffering member 4, the at least one buffering member 4 is disposed on at least one of the at least one upper supporting member 21 and the at least one lower supporting member 31. In this embodiment, the at least one buffering member includes a plurality of buffering members 4, which provides good protection for the boat body 9.

Specifically, the at least one lower supporting member includes two lower supporting members 31, the lower supporting assembly 3 further includes a lower connecting rod 32 and a lower central rod 33, the lower connecting rod 32 extends in the X direction, the lower connecting rod 32 is configured to be connected to the first rod assembly 12, and the lower central rod 33 extends in the Y direction and is connected to the lower connecting rod 32. The lower central rod 33 is configured to restrict a deck 92 of the boat body 9, the lower central rod 33 cooperates with the first supporting segment 311, and the second supporting segment 312 is arranged around and restricts an end of the boat body 9.

Specifically, the first supporting segment 311 is inclined and connected to the lower connecting rod 32 to define a second included angle 62, and the two lower supporting members 31 are arranged, in the X direction, at two sides of the lower central rod 33. In this embodiment, the first included angle 61 is a right angle, the second included angle 62 is larger than 90 degrees, and the two lower supporting members 31 and the lower connecting rod 32 are arranged in a generally C-shaped configuration.

Preferably, the lower supporting assembly 3 is swingably connected to the first rod assembly 12, which is easy to folded and stored. In this embodiment, the lower supporting assembly 3 further includes a lower rotatable seat 34, the lower rotatable seat 34 is rotatably connected to the first rod assembly 12, and the lower connecting rod 32 is positioned to the lower rotatable seat 34.

The lower supporting assembly 3 further includes a closing rod 35, an free end of the second supporting segment 312 of each of the two lower supporting members 31 and the lower central rod 33 define a first opening 71 open toward the Y direction, and the closing rod 35 detachably is detachably connected to the second supporting segments 312 of the two lower supporting members 31 and the lower central rod 33 to bar the two first openings 71. In use, the closing rod 35 may be removed so that more space is provided for disposal of the boat body 9. The two lower supporting members 31, the lower connecting rod 32 and the closing rod 35 are arranged in a generally diamond-shaped configuration.

Preferably, the at least one lower supporting member 31 extends obliquely relative to the Y direction and away from the base 11 so that the at least one lower supporting member 31 can provide various restrictions at different height positions in the Z direction; and taking the lower connecting rod 32 as a reference, the closing rod 35 can restrict the boat body 9 in a relatively high position so that the boat body 9 is prone to leaning against the first rod assembly 12.

The at least one upper supporting member includes two upper supporting members 21, the upper supporting assembly 2 further includes an upper central rod assembly 22, and the upper central rod assembly 22 extends in the Y direction. The upper central rod assembly 22 is configured to restrict a cockpit 93 of the boat body 9, the two upper supporting members 21 are disposed on the upper central rod assembly 22 in interval, and each of the two upper supporting members 21 includes an upper connecting rod 211 which extends in the X direction and two blocking rods 212 which are inclined and connected to opposing ends of the upper connecting rod 211 and extends in the Y direction. The blocking rod 212 is configured to restrict the bottom portion 91 of the boat body 9. Specifically, the two blocking rods 212 of one of the two upper supporting members 21 and the two blocking rods 212 of the other of the two upper supporting members 21 define two second openings 72, respectively. The two second openings 72 are open toward the X direction, and the two second openings 72 provide a light weight and good flexibility for installation of various boat bodies.

Preferably, the upper central rod assembly 22 includes a first rod member 221 and a second rod member 222, the second rod member 222 movably is movably inserted and positioned to the first rod member 221, the upper connecting rod 211 of one of the two upper supporting members 21 is connected to the first rod member 221, and the upper connecting rod 211 of the other of the two upper supporting members 21 is connected to the second rod member 222, so that the distance between the two upper supporting members 21 can be adjusted according to the width of the boat body 9 in the Y direction.

Preferably, the upper supporting assembly 2 is swingably connected to the first rod assembly 12, which is easy to fold and store. In this embodiment, the upper supporting assembly 2 further includes an upper rotatable seat 23, the upper rotatable seat 23 is rotatably connected to the first rod assembly 12, and the first rod member 221 is positioned to the upper rotatable seat 23.

The boat carrier further includes a wheel assembly 5, and the wheel assembly 5 is detachably disposed on the frame 1. With the wheel assembly 5, the boat carrier and the boat body 9 can be easily moved.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A boat carrier, including:
a frame, including a base and a first rod assembly, the base being configured to be connected to a vehicle, the first rod assembly being connected to the base, the first rod assembly extending in a Z direction;
an upper supporting assembly, connected to the first rod assembly, including at least one upper supporting member; and
a lower supporting assembly, connected to the first rod assembly, distanced from and located under the upper supporting assembly in the Z direction, including at least one lower supporting member, the at least one lower supporting member including a first supporting segment and a second supporting segment which extend in a Y direction, the first supporting segment and the second supporting segment defining a first included angle therebetween, the first included angle being directed toward an X direction, wherein the X, Y Z directions are perpendicular to one another.

2. The boat carrier of claim 1, wherein the upper supporting assembly is swingably connected to the first rod assembly.

3. The boat carrier of claim 1, wherein the lower supporting assembly is swingably connected to the first rod assembly.

4. The boat carrier of claim 1, wherein the at least one lower supporting member includes two lower supporting members, the lower supporting assembly further includes a lower connecting rod and a lower central rod, the lower connecting rod extends in the X direction, the lower connecting rod is configured to be connected to the first rod assembly, the lower central rod extends in the Y direction and is connected to the lower connecting rod, the first supporting segment is inclined and connected to the lower connecting rod to define a second included angle, and the two lower supporting members are arranged, in the X direction, at two sides of the lower central rod.

5. The boat carrier of claim 4, wherein the second included angle is larger than 90 degrees.

6. The boat carrier of claim 1, further including at least one buffering member, wherein the at least one buffering member is disposed on at least one of the at least one upper supporting member and the at least one lower supporting member.

7. The boat carrier of claim 1, wherein the at least one upper supporting member includes two upper supporting members, the upper supporting assembly further includes an upper central rod assembly, the upper central rod assembly extends in the Y direction, the two upper supporting members are disposed on the upper central rod assembly in interval, and each of the two upper supporting members includes an upper connecting rod which extends in the X direction and two blocking rods which are inclined and connected to opposing ends of the upper connecting rod and extends in the Y direction.

8. The boat carrier of claim 7, wherein the upper central rod assembly includes a first rod member and a second rod member, the second rod member is movably inserted and positioned to the first rod member, the upper connecting rod of one of the two upper supporting members is connected to the first rod member, and the upper connecting rod of the other of the two upper supporting members is connected to the second rod member.

9. The boat carrier of claim 1, further including a wheel assembly, wherein the wheel assembly is detachably disposed on the frame.

10. The boat carrier of claim 8, wherein the upper supporting assembly is swingably connected to the first rod assembly; the lower supporting assembly is swingably connected to the first rod assembly; the at least one lower supporting member includes two lower supporting members, the lower supporting assembly further includes a lower connecting rod and a lower central rod, the lower connecting rod extends in the X direction, the lower connecting rod is configured to be connected to the first rod assembly, the lower central rod extends in the Y direction and is connected to the lower connecting rod, the first supporting segment is inclined and connected to the lower connecting rod to define a second included angle, and the two lower supporting members are arranged, in the X direction, at two sides of the lower central rod; the second included angle is larger than 90 degrees; the boat carrier further includes at least one buffering member and a wheel assembly, the at least one buffering member is disposed on at least one of the at least one upper supporting member and the at least one lower supporting member, and the wheel assembly is detachably disposed on the frame; the upper supporting assembly further includes an upper rotatable seat, the upper rotatable seat is rotatably connected to the first rod assembly, and the first rod member is positioned to the upper rotatable seat; the lower supporting assembly further includes a lower rotatable seat, the lower rotatable seat is rotatably connected to the first rod assembly, and the lower connecting rod is positioned to the lower rotatable seat; the first included angle is a right angle; the lower supporting assembly further includes a closing rod, an free end of the second supporting segment of each of the two lower supporting members and the lower central rod define a first opening open toward the Y direction, the closing rod is detachably connected to the second supporting segments of the two lower supporting members and the lower central rod to bar the first opening; the two blocking rods of one of the two upper supporting members and the two blocking rods of the other of the two upper supporting members define two second openings, respectively; the two second openings are open toward the X direction; the first rod assembly includes a base rod and an extension rod, the base rod is disposed on the base, the extension rod is movably inserted to the base rod, the upper supporting assembly is connected to the extension rod, and the lower supporting assembly is connected to the base rod; the first supporting segment and the second supporting segment are configured to restrict a bottom portion of a boat body; the lower central rod is configured to restrict a deck of the boat body; the upper central rod assembly is configured to restrict a cockpit of the boat body, and the blocking rod is configured to restrict the bottom portion of the boat body; the at least one lower supporting member extends obliquely relative to the Y direction and away from the base; the at least one lower supporting member is configured to restrict an end portion of the boat body.
